(19) United States
(12) Patent Application Publication
(10) Pub. No.: US 2005/0275212 A1
(43) Pub. Date: Dec. 15, 2005

(54) Flexible truck fender flare with integral front and rear mud flaps

(76) Inventor: Robert J. Angelaitis, Windsor, OH (US)

Correspondence Address: VYTAS R. MATAS, 2412 CEDARWOOD RD., PEPPER PIKE, OH, 44124, US

(21) Appl. No.: 10/866,121

(22) Filed: Jun. 12, 2004

(51) Int. Cl. B62D 25/18

(52) U.S. Cl. 280/847

(57) ABSTRACT

The present invention is drawn to an integrally formed flat flexible fender flare and mud flap assembly made to be easily fitted on existing wheel wells, even ones having existing factory flare sections, which will prevent mud and road debris from being thrown unto the truck body sections such as the front end bumper and the running board.

### BACKGROUND OF THE INVENTION

1. Field of the Invention

The present invention generally relates to truck fender flares and more particularly to such flares having mud flaps formed thereon.

2. Description of the Prior Art

Trucks such as the 2003 GMC Model 2500 have their front ends formed to have a gap between the top of the front end bumper and the parking light housign assembly. The front wheels have a tendency to throw up mud and road debry into the wheel well when traveling through puddles and muddy off road trails. The heavy threads of the truck tires tend to retain the mud and debris causing these particles to not only be thrown into the rear of the wheel well but also through the space between the front bumper and the parking light housing onto the front end of the truck. This note only results in a dirty front end but also caused denting and damage thereto by hard particles such as pebbles impacting the front bumper and adjoining assembly.

Truck fender wheel well flare sections are known as seen in U.S. Pat. Nos. 6,070,908 and 5,340,154.

The U.S. Pat. No. 6,070,908 patent teaches a diamond plate aluminum fender extension (14) or flare having a separate mud flap (30) mounted at the door end of the wheel well. There is no teaching of any type of mud flap mounted to the front bumper end of the wheel well let alone a flexible plastic flare having an integrally formed front bumper mud flap.

The U.S. Pat. No. 5,340,154 patent while teaching a plastic material front wheel well flare having a section (42) at the door end of the well again fails to teach any structure which would prevent road particles to be thrown through the gap between the front bumper and the light housing.

In view of the foregoing it will be seen that an integrally formed front wheel well flare and front bumper mud flap was sorely needed for trucks having a gap between the front bumper and the light assembly housing.

### SUMMARY OF THE INVENTION

The present invention is drawn to an integrally fomned flexible fender flare and mud flap easily formed to fit on existing wheel wells, even one having existing factory flare sections, which will prevent and road debris to be thrown into the front end bumper and housing sections.

To accomplish this a flexible plastic flare section is formed to have wide end sections extending below the front bumper at one end and below the running board at the other end. The connecting top section is formed to follow the width of the wheel well top section or flare to make sure a ledge section is not formed in the wheel well, which would retain corrosive road liquids from salted streets. The end section facing the front bumper has a cut out section inside the well to prevent the front wheel from scraping this end section during a hard turn when the front wheel is turned into the well.

In view of the foregoing it will be seen that one aspect of the present invention is to provide an internal front wheel well flare having means for preventing road debris from hitting the front bumper and lighting assembly.

Another aspect is to provide an flexible wheel well flare having front and rear mud flaps.

Yet another aspect is to provide a wheel well flare, which has no shelf sections, formed in the well by mounting the flare therein.

Still another aspect is to provide an integral front wheel well flare and bumper mud flap, which will not interfere with the turning of the wheel into the well.

These and other aspects of the present invention will be more fully understood after consideration of the following description of the preferred embodiment along with the accompanying drawings.

### BRIEF DESCRIPTION OF THE DRAWINGS

In the drawings wherein:

FIG. 1 is a detailed view of the front end of a truck showing a gap between the front bumper section and the light assembly, which is open to the wheel well.

FIG. 2 shows the FIG. 1 gap as sealed by the integral wheel flare and mud flap of the present invention.

FIG. 3 shows the integral front wheel well flare and mud flaps of the present invention prior to installation.

FIG. 4 shows the FIG. 3 integral flare section and font and rear mud flaps of the present invention installed in the front wheel well.

FIG. 5 shows the integral rear wheel well flare and mud flap of the present invention prior to installation.

FIG. 6 shows the installed rear wheel flairs of FIG. 5.

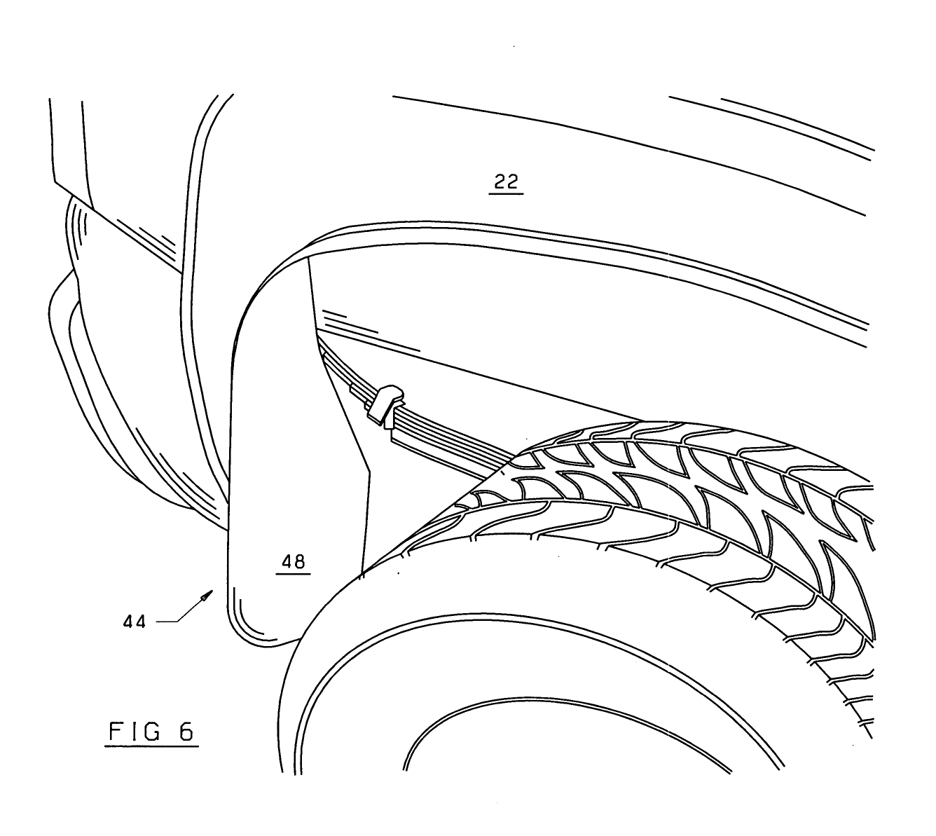

FIG. 7 shows the attachments of the FIG. 5 flare to protect the running board.

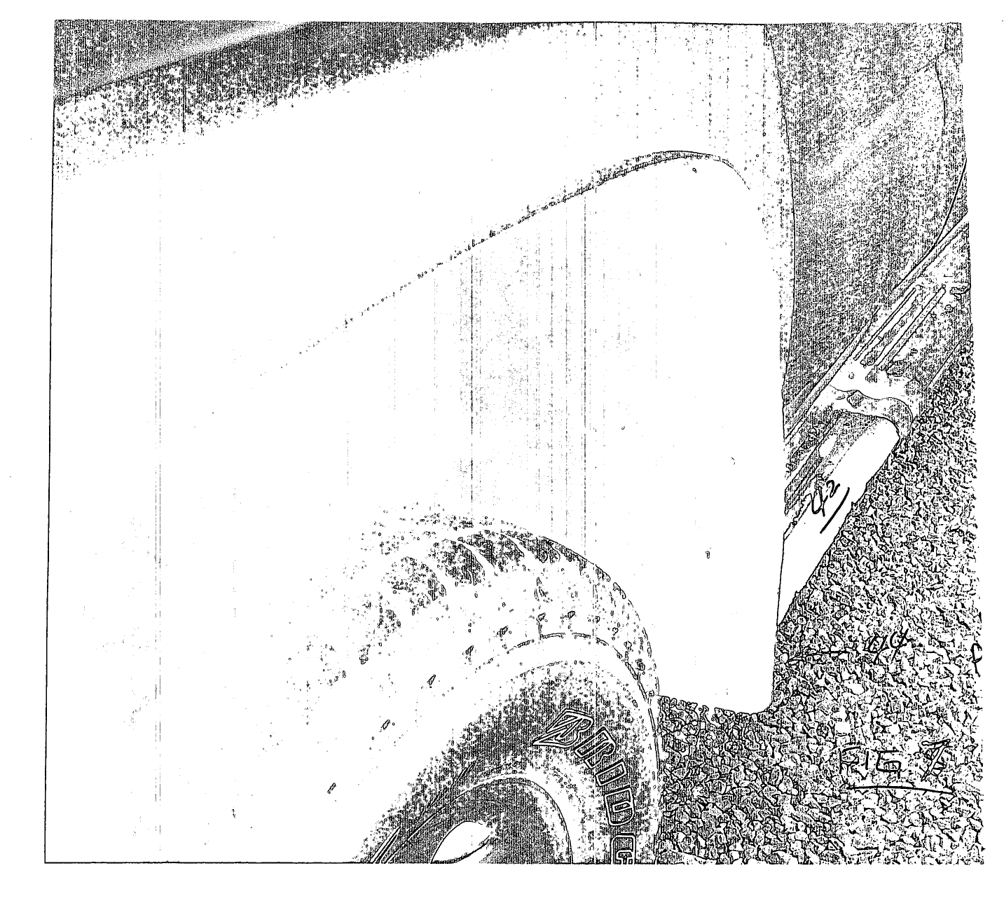

### DESCRIPTION OF THE PREFERRED EMBODIMENT

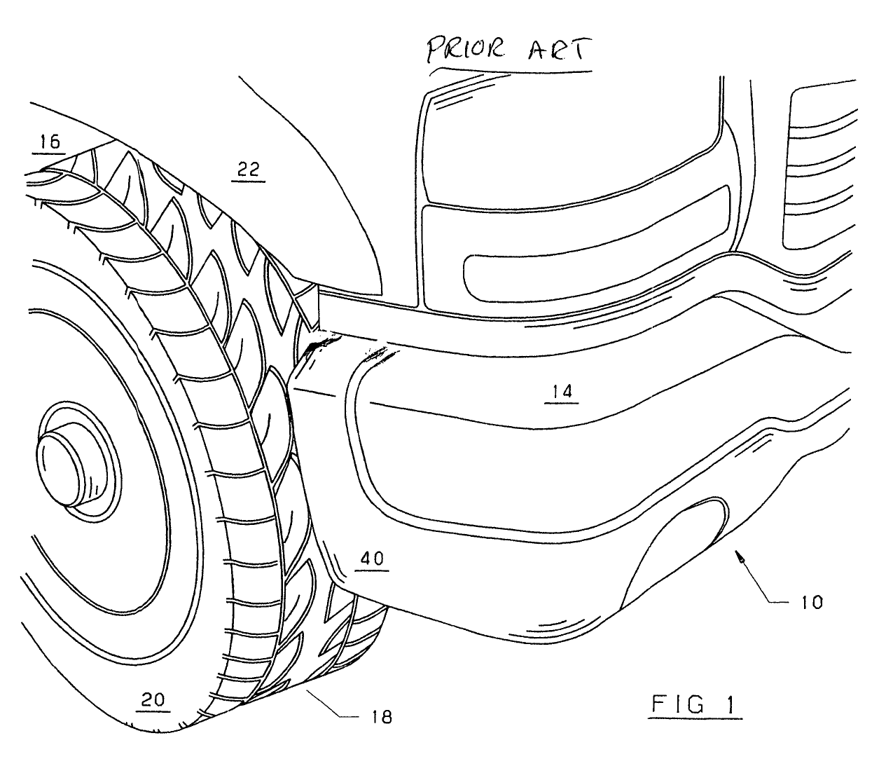

Referring now to the drawings generally and to FIGS. 1 through 4 in particular, FIG. 1 clearly illustrates the problem presented by the front wheel well design of many heavy-duty trucks such as the 2003 GMC 2500. The front bumper assembly (10) is spaced from the upper front-end assembly (12) to have a gap (14), which is open to the wheel well (16). When the truck is traveling through mud and gravel such as is found in off road conditions the threads (18) on the heavy truck tire (20) tend to retain this mud and debris to throw it into the entire well (16) and through the gap (14) unto the bumper assembly (10) and the upper front end (12) making it hard to clean as well as denting and scratching it from heavy particle impact. It is seen that even though the truck has a factory flare unit (22) it provides no protection from gap (14) nor any rear mud flap for the wheel (20).

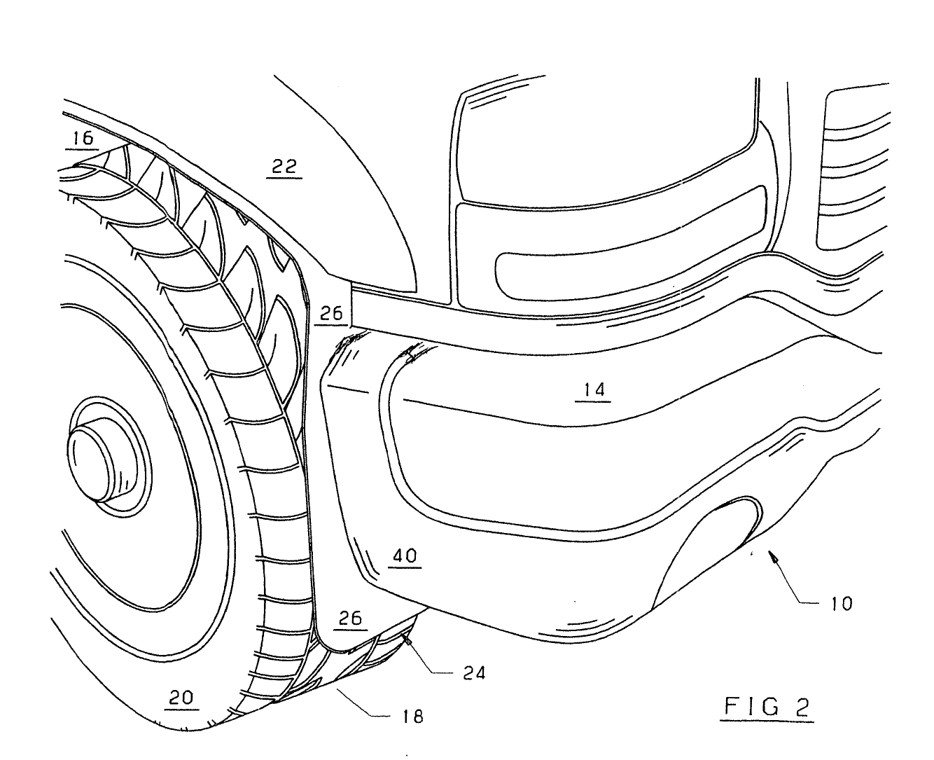

Referring now to FIGS. 2-4, an integral extended wheel well flare assembly (24) is shown having a front mud flap section (26) as well as a rear mud flap section (28). The mud flap sections (26, 28) are connected to a narrow central section (30) which has a width W that will not exceed the width of the top inside section (32) of the factory flare (22) while leaving an extended section (34) to protrude from the factory flare (22). This prevents forming any ledges inside the wheel well for trapping mud and debris.

The front mud flap section (26) effectively blocks the wheel well front section communicating with the gap (14) to prevent any mud and debris from splashing unto the bumper assembly (10) and the light assembly (12). The front mud flap section (26) also has a cut back section (36) which mounts along the inside of the wheel well (16) to prevent the wheel (20) from scraping the front mud flap (26) during a hard turn into the wheel well (16).

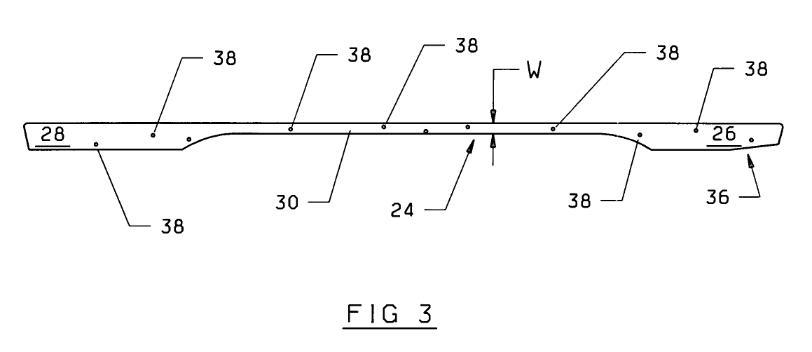

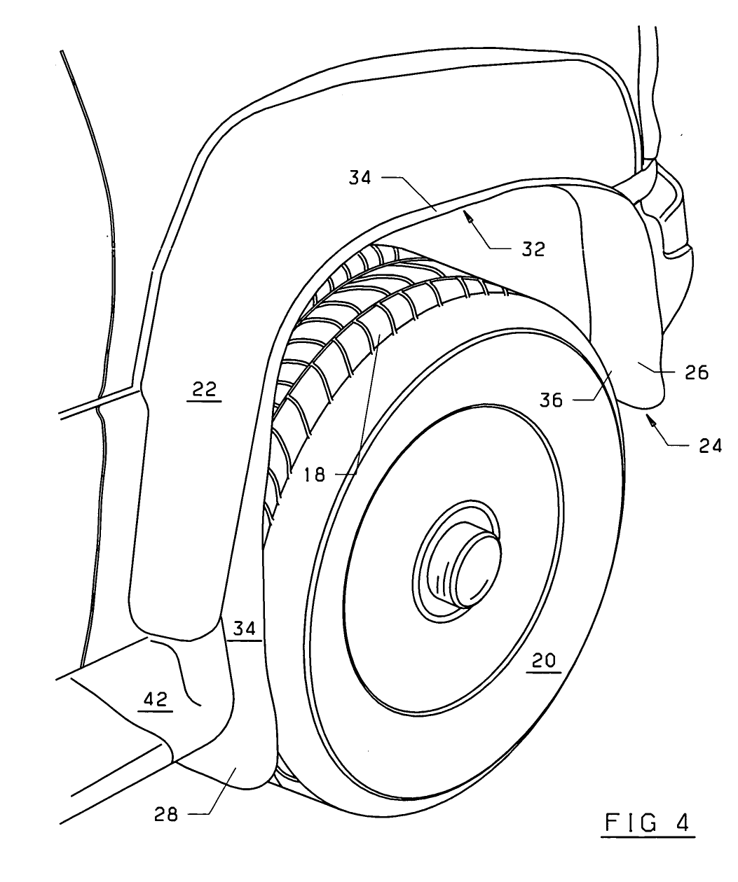

As is best seen in FIGS. 3, 4 the front wheel flare and mud flap assembly is formed as a flat sheet of i/8 inch thick flexible polyethylene known as POLYSTONEG. This material is black and matches the factory flare section (22) to appear as original equipment when mounted to the factory flare (22). Mounting is done by stainless steel screws being screwed into the top and sides of the flare (22) through holes (38) found in the front wheel well assembly (24) in a known manner.

When thus installed, the assembly (24) has the front mud flap section extend below end (40) of front bumper assembly (10) leaving the extended ridge (34) around the factory flare (22) and the rear mud flap section (28) extending below the factory flare as well s the running board (42). These extensions and ridge (34) help minimize mud and debris deposit on the running board.

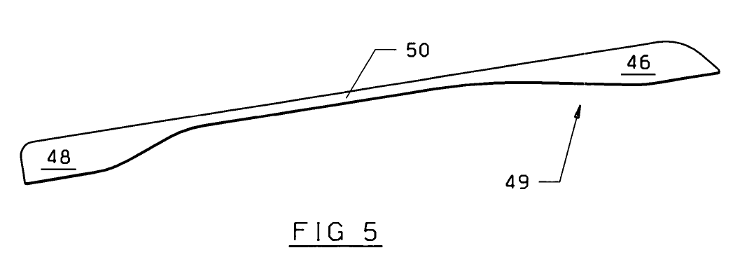

As best seen in FIG. 5, the rear wheel integral flare and mud flap assembly (44) is also formed as a i/8 inch thick polyethylene flexible flat plastic sheet having a front mud flap section (46) and a rear mud flap section (4*) formed at ends of a narrow section (50). It is mounted to the factory flare (22) by stainless steel screws as discussed earlier as well as to the running board (42). The front mud flap (46) extends below the running board (42) and prevents mud and debris from being splashed and caked thereon.

It will be understood that certain details and modifications have been deleted herein for the sake of conciseness and readability but are intended to fall within the scope of the following claims. As an example the integral flare and mud flap assembly could be mounted to truck fenders instead of the factory flare if such is not provided. Also the flexible plastic material could be changed or painted to match the color of the fender to give it a factory assembly look.

1. An integral wheel well flare and mud flap assembly for a truck comprising;
a truck fender assembly covering a wheel well;
a flexible flare extending from said wheel well of said truck fender assembly having an integrally formed front mud flap section for preventing any mud and debry from being thrown from the front of said wheel well unto the body of the truck.

2. A flare and mud flap assembly as set forth in claim 1 wherein said flexible flare further includes a back mud flap section.

3. A flare and mud flap assembly as set forth in claim 1 wherein said truck has a gap between a front bumper assembly and a headlight assembly providing an opening to a front wheel well of said truck and wherein said front mud flap section blocks said gap preventing mud and debry from being thrown by said truck wheel onto said bumper assembly of said truck.

4. A flare and mud flap assembly as set forth in claim 3 wherein said front mud flap has a cut out section along the front of said wheel well preventing scraping of said truck wheel on said flare during a turn of said wheel into said wheel well.

5. A flare and mud flap assembly as set forth in claim 2 wherein said truck includes a running board extending from said front wheel well of said truck and wherein said back mud flap section of said front wheel well and flare assembly extends below said running board to prevent mud and debries from collecting on said running board.

6. A flare and mud flap assembly as set forth in claim 5 wherein said flare includes a thin central section connected to a top section of said fender extending from said wheel well so as to extend out from said fender but not to extend into said wheel well so as to prevent forming a ledge therein onto which mud and debries could collect.

7. A flare and mud flap assembly as set forth in claim 6 wherein said flare is formed from a flexible polyethelyne plastic sheet.

8. A flare and mud flap assembly as set forth in claim 6 wherein said flexible polyethelyne is POLYSTONE G of approximately 1/8 inch thickness.

9. A flare and mud flap assembly as set forth in claim 2 wherein said truck has a running board extending to a back wheel well of said truck and said flare assembly is mounted in said back wheel well with said front mud flap extending below said running board to prevent mud and debries from being thrown unto said running board.

10. A flare and mud flap assembly as set forth in claim 9 wherein said truck fender around said wheel well includes a factory installed flare and said flare assembly is mounted thereto.

11. A flat flexible plastic flare and mud flap assembly for a front wheel well of a truck comprising:
a first mud flap section having a rectangularly shaped front area for mounting to front wheel well section to block any gaps between the wheel well and the front bumper section of the truck;
a narrow rectangular section extending from an end of said first mud flap section for mounting to the top section of the front wheel well; and
a second mud flap section having a rectangularly shaped section extending from said narrow rectangular section for mounting to back portion of said front wheel well.

12. A flat flexible plastic flare and mud flap assembly as set forth in claim 11 where said first mud flap section has a cut out section along the end thereof to prevent front wheel interference when the flare assembly is mounted to the front wheel well.

13. A flat flexible flare and mud flap assembly as set forth in claim 12 wherein said first mud flap section, said narrow rectangular section and said second mud flap section are integrally formed from a polyethelyne plastic material.

14. A flat flexible flare and mud flap assembly as set forth in claim 13 wherein said plastic material is POLYSTONE G of approximately 1/8 thickness.

15. A flat flexible plastic flare and mud flap assembly for a rear wheel well of a truck comprising:
a first mud flap section having a rectangularly shaped front area for mounting to the rear wheel well section to block any gaps between the wheel well and a running board section of the truck;
a narrow rectangular section extending from an end of said first mud flap section for mounting to the top section of the rear wheel well; and
a second mud flap section having a rectangularly shaped section extending from said narrow rectangular section for mounting to a back portion of said rear wheel well.

16. A flat flexible plastic flare and mud flap assembly as set forth in claim 15 where said first mud flap section extends below said running board

17. A flat flexible flare and mud flap assembly as set forth in claim 15 wherein said first mud flap section, said narrow rectangular section and said second mud flap section are integrally formed from a polyethelyne plastic material.

18. A flat flexible flare and mud flap assembly as set forth in claim 13 wherein said plastic material is POLYSTONE G of approximately 1/8″ thickness.
